(19) United States
(12) Patent Application Publication
(10) Pub. No.: US 2006/0223640 A1
(43) Pub. Date: Oct. 5, 2006

(54) Rotational coupling with overload protection

(76) Inventors: Michael L. Bassett, Auburn, IN (US); Mark L. Beakas, Auburn, IN (US); Daniel V. Gochenour, Auburn, IN (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/099,130

(22) Filed: Apr. 5, 2005

(51) Int. Cl. F16D 7/02

(52) U.S. Cl. 464/30

(57) ABSTRACT

A rotational coupling assembly for transmitting torque between a driving member and a driven member includes a torsionally compliant component having first and second rotary torque transmitting members rotatable relative to one another throughout a first angular distance, and a compliant member that provides a resilient driving connection between the first and second rotary torque transmitting members within the first angular distance. A torque overload protection component is secured for rotation with the driving member and is rotatable relative to the second rotary torque transmitting member throughout a second angular distance. The overload protection component includes a rotation limiting connector adapted to selectively establish a driving connection between the overload protection component and the second rotary torque transmitting member to limit the amount of torque transmitted through the torsionally compliant component. A torque transmitting device that includes a rotational coupling assembly is also provided.

### BACKGROUND OF THE INVENTION

1. Field of the Invention

The present invention relates in general to coupling devices for connecting first and second members together for concurrent rotation. In particular, the present invention relates to an improved rotational coupling assembly for use between such first and second members.

2. Description of the Related Art

Rotational coupling devices are structures adapted to connect first and second members together for concurrent rotation. For example, in the context of a vehicle powertrain system, a rotational coupling device may be used to connect a source of rotational power, such as an engine flywheel, to a rotatably driven device, such as a friction clutch or transmission. In some instances, the rotational coupling device provides a direct connection between the two members such that the flywheel constantly rotatably drives the clutch or transmission. In other instances, the rotational coupling device is provided within a clutch that selectively connects the two members such that the flywheel intermittently rotatably drives an input shaft of the transmission.

In a dual mass powertrain system, for example, a first rotational mass includes the engine flywheel and a second rotation mass includes a clutch assembly. The first rotational mass is connected to the second rotational mass through a rotational coupling device that includes a torsionally compliant element, commonly a spring damper, that contributes to both inertial masses. In general, as the excitation frequency produced by the engine matches the natural frequency of the flywheel, rotational coupling device and clutch assembly, the resulting torsional vibration levels increase dramatically until the engine reaches a sufficient speed so as to increase the engine's excitation torsional frequency above the natural frequency of the powertrain components.

Since high levels of torsional vibration can damage the powertrain and are disconcerting to the operator, the torsionally compliant element may be used to tune the powertrain system by moving its natural frequency outside the range of general operation. Additionally, the torsionally compliant element may reduce the magnitude of torsional vibrations transmitted through the rotational coupling device by damping these vibrations. While torsionally compliant elements have proven effective for tuning powertrain systems and reducing the level of torsional vibrations therein, they are often subject to damage when significantly loaded. In a dual mass powertrain system, for example, the relatively high inertial mass of the clutch assembly creates a significant impact load on the torsionally compliant element during engine start-up.

### SUMMARY OF THE INVENTION

A rotational coupling assembly for transmitting torque between a driving member and a driven member is provided that includes a torsionally compliant component having first and second rotary torque transmitting members rotatable relative to one another throughout a first angular distance, and a compliant member that provides a resilient driving connection between the first and second rotary torque transmitting members within the first angular distance. A torque overload protection component is secured for rotation with the driving member and is rotatable relative to the second rotary torque transmitting member throughout a second angular distance. The overload protection component includes a rotation limiting connector adapted to selectively establish a driving connection between the overload protection component and the second rotary torque transmitting member to limit the amount of torque transmitted through the torsionally compliant component. A torque transmitting device that includes a rotational coupling assembly according to an embodiment of the present invention is also provided.

### BRIEF DESCRIPTION OF THE DRAWINGS

The features and inventive aspects of the present invention will become more apparent upon reading the following detailed description, claims, and drawings, of which the following is a brief description:

FIG. 1 is a cross-sectional view of an exemplary torque transmitting device that includes a friction clutch and a rotational coupling assembly according to an embodiment of the present invention;

FIG. 2 is a cross-sectional view of the rotational coupling assembly of FIG. 1;

FIG. 3 is a rear elevation view of the rotational coupling assembly of FIG. 2;

FIGS. 3A and 3B are detailed views of the rotational coupling assembly of FIG. 3;

FIG. 4 is a graphical representation of torque transmission versus angular displacement of relatively rotating components of the rotational coupling assembly shown in FIGS. 1-3;

FIG. 5 is a cross-sectional view of a rotational coupling assembly according to another embodiment of the present invention;

FIG. 6 is a rear elevation view of the rotational coupling assembly of FIG. 5;

FIG. 7 is a rear elevation view of a rotational coupling assembly according to another embodiment of the present invention;

FIG. 8 is a cross-sectional view of a rotational coupling assembly according to another embodiment of the present invention;

FIG. 9 is a cross-sectional view of a rotational coupling assembly according to another embodiment of the present invention;

FIG. 10 is a rear elevation view of the rotational coupling assembly of FIG. 9; and

FIG. 11 is a cross-sectional view of a rotational coupling assembly according to another embodiment of the present invention.

### DETAILED DESCRIPTION

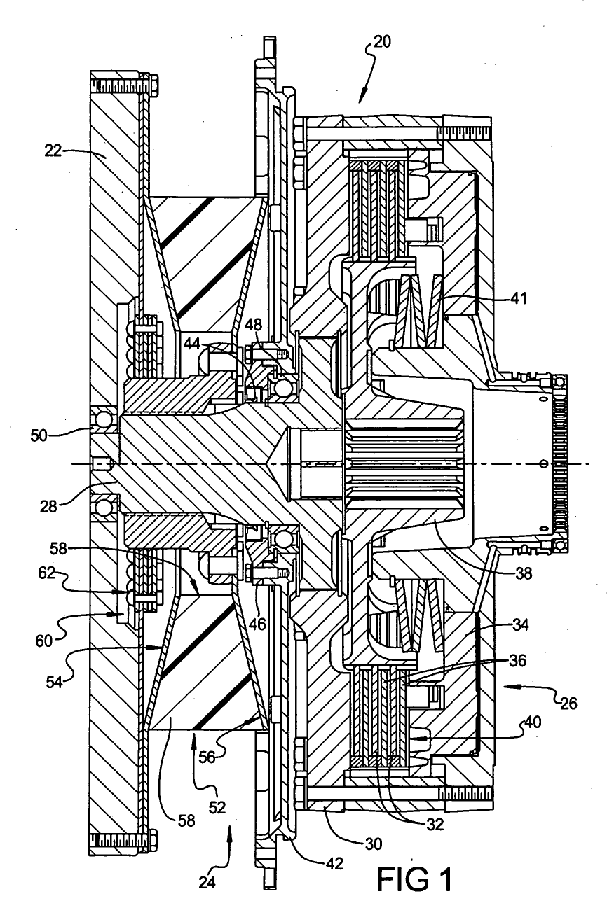

FIG. 1 is a cross-sectional view of an exemplary torque transmitting device 20 for transmitting torque between a driving member and a driven member. In the illustrated embodiment, torque transmitting device 20 comprises a dual mass clutch system used to frictionally and rotationally link an internal combustion engine flywheel 22 to a transmission (not shown). The engine flywheel 22 is rotatably driven by an internal combustion engine in a generally non-uniform fashion due to combustion torque pulses. The torque pulses generate torsional vibrations in flywheel 22. A rotational coupling assembly 24 is used to tune the clutch system by moving its natural frequency outside the range of general operation. Rotational coupling assembly 24 may also be used to dampen the torsional vibrations.

By way of example, the torque transmitting device 20 shown in FIG. 1 includes a driven member comprising a fluid pressure actuated function clutch 26 having an input shaft 28, a clutch input hub 30 with drive friction discs 32, and a fluid pressure-actuated pressure plate 34. Friction clutch 26 also includes driven friction discs 36 and an output hub 38 adapted for driving attachment to a transmission input shaft (not shown). Drive and driven friction discs 32, 36 cooperatively form a clutch pack 40. As clutch pack 40 is loaded or engaged by pressure plate 34, the frictional coupling between drive friction discs 32 and driven friction discs 36 causes output hub 38 to rotate with input hub 30 and input shaft 28. A spring 41, such as a Belleville spring, biases the pressure plate 34 away from clutch pack 40. While friction clutch 26 is shown and described as using fluid pressure to load clutch pack 40, a spring or ball ramp actuator, centrifugal mechanism or other load generating device may be used as an alternative.

In the exemplary torque transmitting device 20, a clutch housing faceplate 42 is positioned between clutch 26 and rotational coupling assembly 24. Clutch input shaft 28 is typically contacted by a seal 44 to prevent migration or leakage of hydraulic fluid used in clutch 26. Seal 44 may be mounted in a seal plate 46, which is attached to clutch housing faceplate 42. A support bearing 48 may be mounted in clutch housing faceplate 42 and, along with a front bearing 50, rotatably supports clutch input shaft 28.

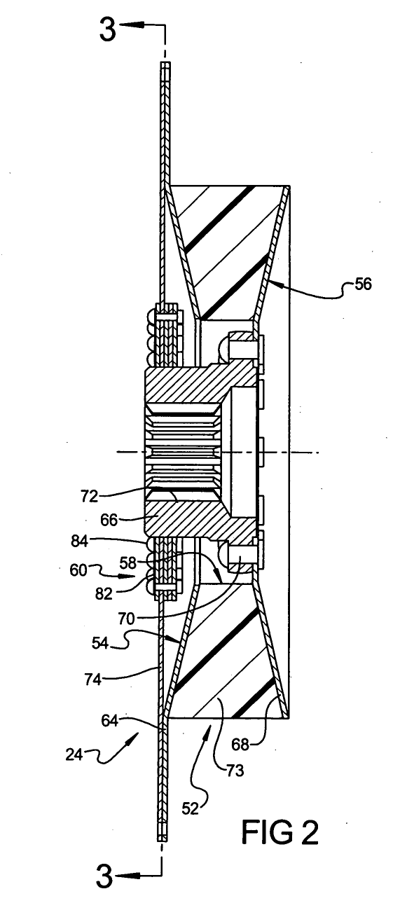

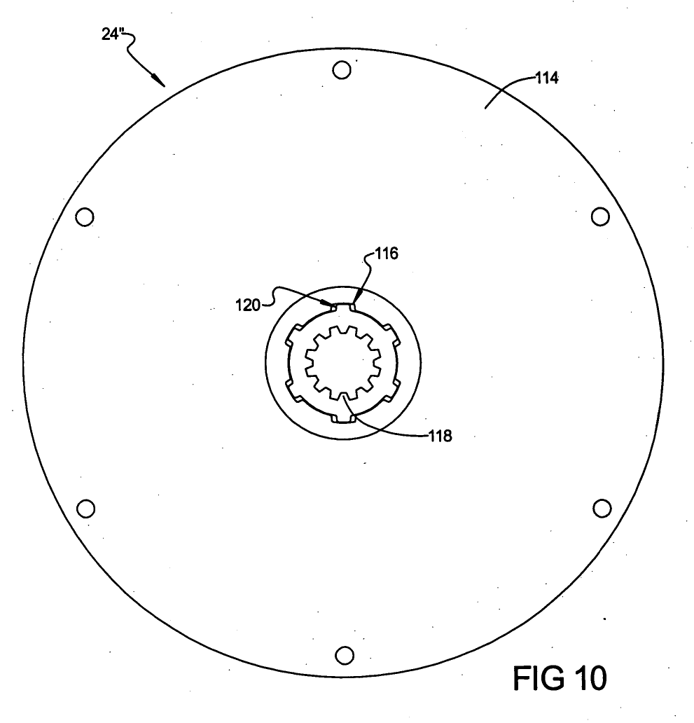

Referring to FIGS. 2-11, several embodiments of rotational coupling assembly 24 are shown in greater detail. In each of the several embodiments, which are not intended to be limited to the embodiments shown and described, rotational coupling assembly 24 includes a torsionally compliant component 52 having first and second rotary torque transmitting members 54 and 56, respectively, which are rotatable relative to one another throughout a first angular distance. A compliant member 58 provides a resilient driving connection between first and second rotary torque transmitting members 54, 56 within the first angular distance.

Rotational coupling assembly 24 also includes a torque overload protection component 60 secured for rotation with flywheel 22. Torque overload protection component 60 is rotatable relative to second rotary torque transmitting member 56 throughout a second angular distance. Torque overload protection component 60 includes a rotation limiting connector 62 adapted to selectively establish a driving connection between the overload protection component 60 and the second rotary torque transmitting member 56 to limit the amount of torque transmitted through torsionally compliant component 52.

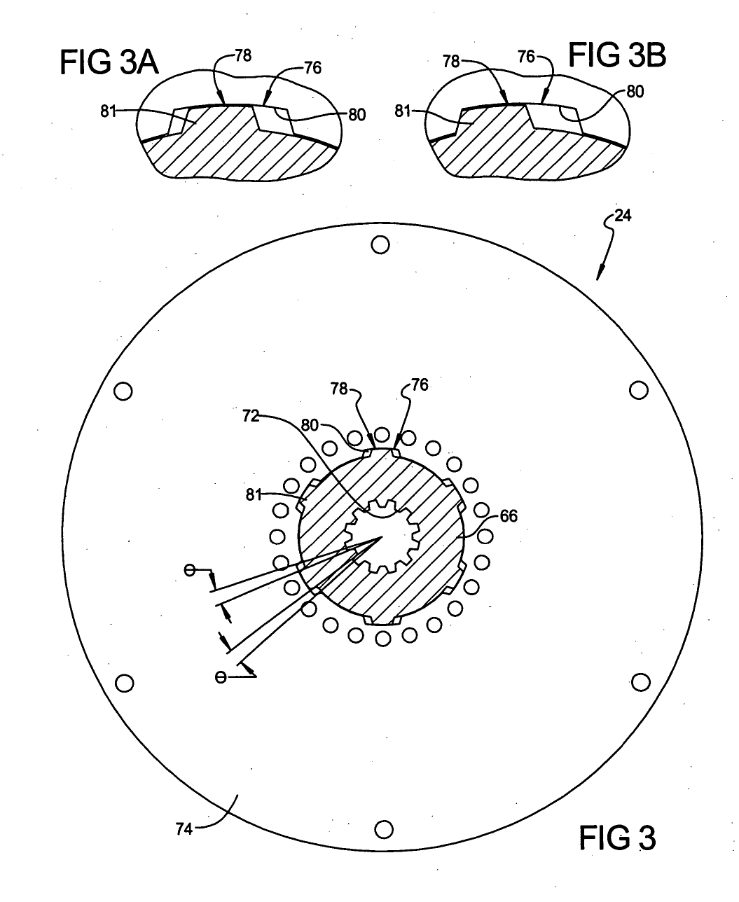

With specific reference to the embodiment of rotational coupling assembly 24 shown in FIGS. 2 and 3, first rotary torque transmitting member 54 includes a first generally annular disc plate 64 secured for rotation with flywheel 22. Second rotary torque transmitting member 56 includes a hub 66 and a second disc plate 68 that may be secured to hub 66 using a plurality of fasteners 70, such as rivets and the like. Hub 66 is non-rotatably connected to clutch input shaft 28 via a spline 72. In the illustrated embodiment, compliant member 58 includes a generally trapezoidal-shaped, resilient polymeric coupling or coupler 73 that is secured or connected to each of the first and second disc plates 64, 68. The resilient polymeric coupler 73 is adapted to transmit torque, while allowing a predetermined degree of relative rotation between the first and second disc plates 64, 68.

In the embodiment shown in FIGS. 2 and 3, overload protection component 60 includes a generally annular rotary torque transmitting plate 74 that is also secured for rotation with flywheel 22. As shown in FIG. 3, rotary torque transmitting plate 74 includes a first spline 76 and hub 66 includes a second spline 78 adapted to mate with first spline 76 to establish a driving connection when rotation of rotary torque transmitting plate 74 relative to hub 66 exceeds a predetermined angular distance θ.

In the embodiment shown in FIG. 3, for example, first spline 76 is an internal spline having a number of grooves 80 that receive teeth 81 of the external second spline 78. The angular width of each groove 80 is greater than the angular width of teeth 81, which allows rotary torque transmitting plate 74 and hub 66 to rotate relative to one another the predetermined angular distance θ, as measured from a neutral, no-load state shown in FIG. 3. For example, grooves 80 and teeth 81 may be configured to allow approximately 10° of rotation (θ≅10°) between rotary torque transmitting plate 74 and hub 66 in a clockwise or counterclockwise direction before teeth 81 engage rotary torque transmitting plate 74 and form a torque-transmitting connection therebetween.

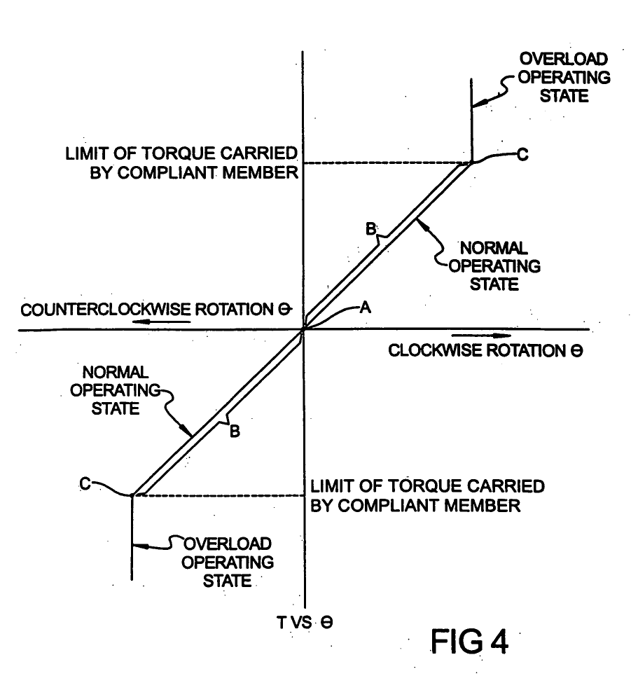

Detailed illustrations of rotary torque transmitting plate 74 and hub 66 are shown in FIGS. 3A and 3B during a normal operating state and an overload operating state, respectively. FIG. 3A illustrates first and second splines 76, 78 under load with substantially all of the torque transmitted by vibration damping assembly 24 flowing from first disc plate 64 through compliant member 58 and into hub 66 via second disc plate 68. In contrast, FIG. 3B illustrates first and second splines 76, 78 when compliant member 58 is in an overload operating state. In this state, a portion of the torque being transmitted by vibration damping assembly 24 flows through torsionally compliant component 52 and the remaining torque flows through rotary torque transmitting plate 74 into hub 66 by virtue of their engagement via splines 76, 78. FIG. 4 graphically illustrates normal and overload operating states of rotational coupling assembly 24 for relative rotation of rotary torque transmitting plate 74 and hub 66.

To accommodate relatively high impact loads when splines 76, 78 engage, the width of rotary torque transmitting plate 74 may be increased substantially, particularly when compared to the width of first and second disc plates 64, 68. Alternatively, as shown in FIG. 2, rotary torque transmitting plate 74 may be reinforced with at least one reinforcing plate 82, which may be secured or connected to rotary torque transmitting plate 74 using a plurality of fasteners 84, such as rivets and the like. When so configured, each reinforcing plate 80 may include a similar internal spline profile as rotary torque transmitting plate 74.

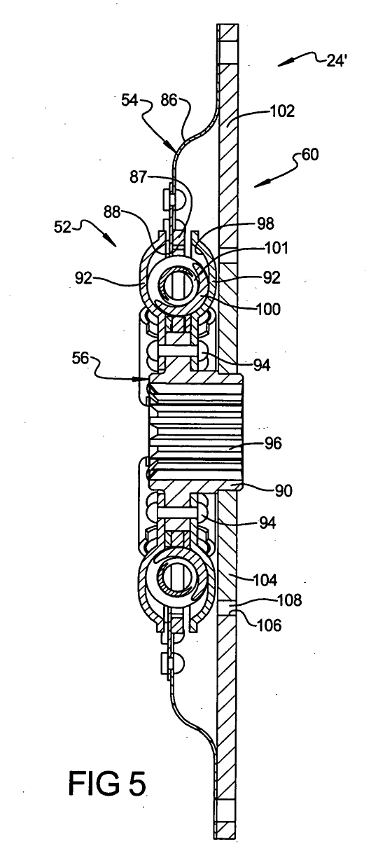

Referring now to FIGS. 5-7, a rotational coupling assembly 24′ according to another embodiment of the present invention is shown. In the illustrated embodiment, first rotary torque transmitting member 54 of torsionally compliant component 52 includes a first generally annular disc plate 86. First disc plate 86 may include a generally annular reinforcing plate 87 that is secured or connected to first disc plate 86 by welding or riveting disc plate 86 to reinforcing plate 87. Reinforcing plate 87 may include a plurality of spring pockets 88.

As shown in FIG. 5, second rotary torque transmitting member 56 includes a hub 90 having a pair of second disc plates 92 secured thereto using a plurality of fasteners 94, such as rivets and the like. Hub 90 is non-rotatably connected to clutch input shaft 28 via a spline 96. In the illustrated embodiment, second disc plates 92 include a plurality of spring cavities 98 circularly arranged proximate an outer periphery of second disc plates 92. Each spring cavity 98 holds captive a first or outer spring 100 and a second or inner spring 101, which cooperatively comprise compliant member 58. First and second springs 100 and 101 may be compression-type coil springs, wherein first spring 100 has a diameter to be closely received within the boundaries of spring cavity 98 and second spring 101 being sized with an outside diameter to be coaxially received within first spring 100. First and second springs 100, 101 are disposed in spring pockets 88 in reinforcing plate 87 and spring cavities 98 in second disc plates 92. Relative rotation of first disc plate 86 and annular reinforcing plate 87 relative to second disc plates 92 compresses springs 100, 101. Like polymeric coupler 73 described above, springs 100, 101 transmit torque between second disc plates 92 and first disc plate 86.

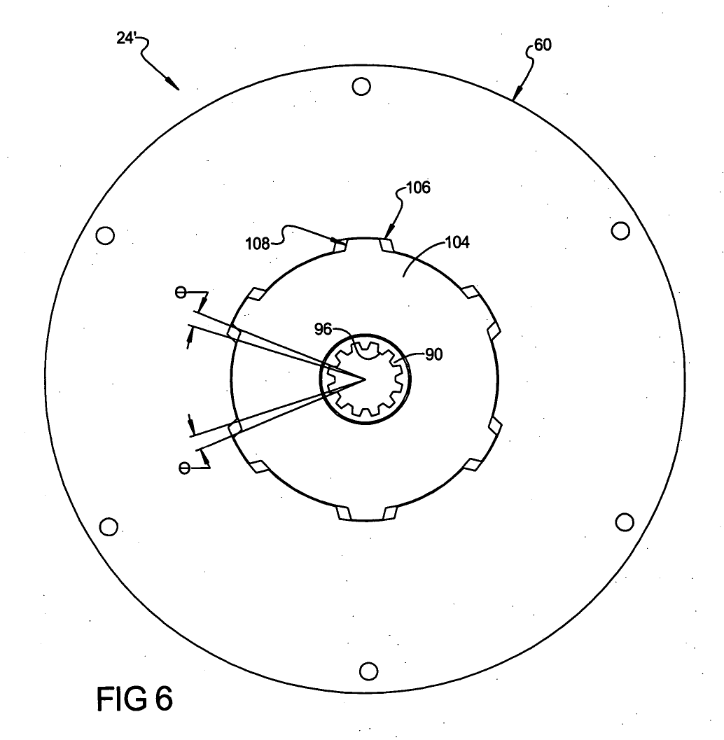

In the embodiment shown in FIGS. 5 and 6, overload protection component 60 includes a first rotary torque transmitting plate 102 secured for rotation with flywheel 22 and a second rotary torque transmitting plate 104 secured for rotation with hub 90 of second rotary torque transmitting member 56. In the illustrated embodiment, first rotary torque transmitting plate 102 includes a first or internal spine 106 and second rotary torque transmitting plate 104 includes a second or external spline 108 adapted to mate with first spline 106 to establish a driving connection when rotation of first rotary torque transmitting plate 102 relative to second rotary torque transmitting plate 104 exceeds a predetermined angular distance θ.

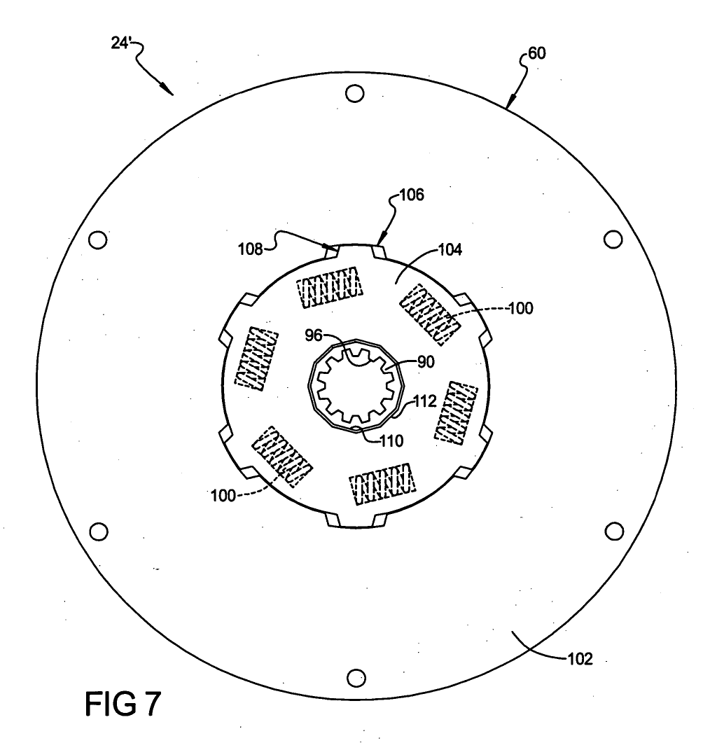

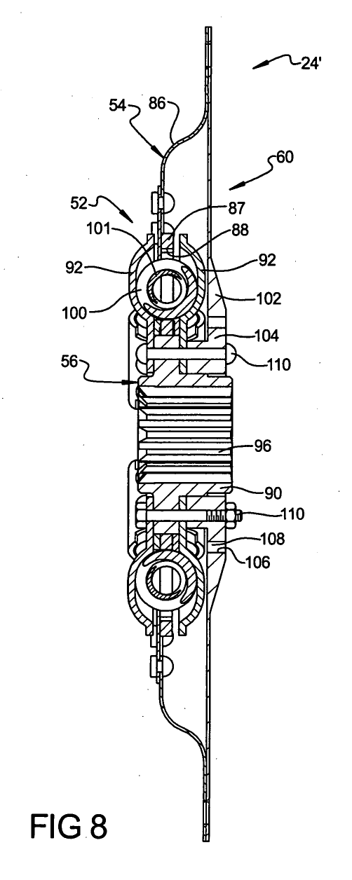

Second rotary torque transmitting plate 104 may, for example, be secured or connected to hub 90 using a shrink-fit or press-fit style connection, as shown in FIGS. 5-7. When so configured, second rotary torque transmitting plate 104 may include a polygon-shaped opening 110 sized to receive a corresponding polygon-shaped outer surface 112 of hub 90 (see, e.g., FIG. 7). A polygon-shaped connection increases the torque carrying capacity of the joint and facilitates the orientation of first and second rotary torque transmitting plates 102 relative to springs 100, 101 in compliant member 58 so that the maximum compliant member load is substantially equal in either a clockwise or counterclockwise rotational direction. For example, FIG. 7 illustrates an orientation of springs 100, 101 (shown hidden in FIG. 7, but not a component within second rotary torque transmitting plate 104) relative to the polygon-shaped joint. Alternatively, the torque carrying capacity of the joint between hub 90 and second rotary torque transmitting plate 104 may be increased by securing second rotary torque transmitting plate 104 to hub 90 using a plurality of fasteners 110 (see, e.g., FIG. 8), such as rivets, bolts or a combination thereof, which may be used in lieu of or in combination with fasteners 94 that secure second disc plates 92 to hub 90.

It should be appreciated that torsionally compliant component 52 shown in FIGS. 5 and 8 falls into a category of devices which can be generally described as spring dampers. The spring-operated torsionally compliant component illustrated in FIGS. 5 and 7 is not limited to that shown and described, and may include other spring-operated configurations that provide rotational compliance between two rotating elements. For example, reinforcing plate 87 and hub 90 may be configured with a rotation limiting connection (e.g., splined interface) that permits rotation of reinforcing plate 87 relative to hub 90 through a first angular distance. While the rotation limiting connection may prevent excessive compressing and stressing of springs 100 and 101, the structural components of torsionally compliant component 52 are still subject to the torque load applied to torsionally compliant component 52 beyond the load required to engage the rotation limiting connection. To redirect any overload torque away from torsionally compliant component 52, torque overload protection component 60 may be configured such that predetermined angular distance θ is generally less than or substantially equal to the first angular distance reinforcing plate 87 and hub 90 are permitted to rotate relative to one another.

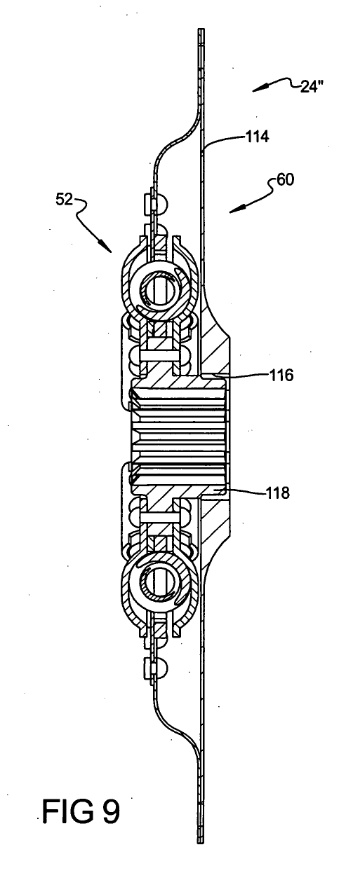

Referring now to FIGS. 9-11, a rotational coupling assembly 24″ according to another embodiment of the present invention is shown. In the illustrated embodiment, torsionally compliant component 52 is substantially similar to the torsionally compliant component described above with respect to FIG. 5. Overload protection component 60 includes a rotary torque transmitting plate 114 secured for rotation with flywheel 22. Rotary torque transmitting plate 114 has a first or internal spine 116 and a hub 118 includes a second or external spline 120 adapted to mate with first spline 116 to establish a driving connection when rotation of rotary torque transmitting plate 114 relative to hub exceeds a predetermined angular distance θ.

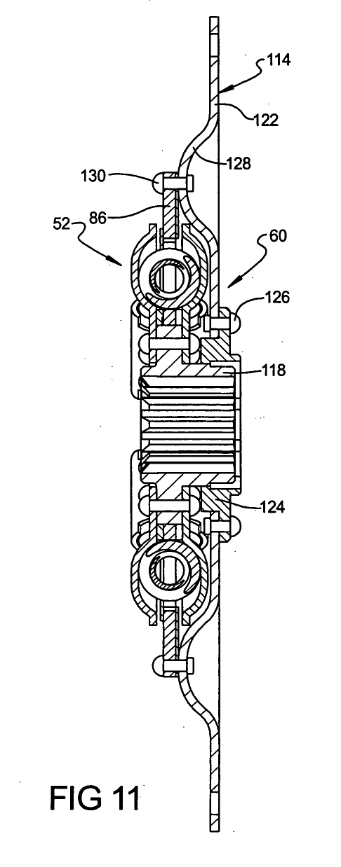

To accommodate relatively high impact loads when splines 116, 120 engage, rotary torque transmitting plate 114 may be thickened adjacent hub 118 (see, e.g., FIG. 9). Alternatively, as shown in FIG. 11, rotary torque transmitting plate 114 may include a first, relatively thin plate portion 122 secured for rotation with flywheel 22 and a second, relatively thicker plate portion 124 splined to hub 118 and secured to first plate portion 122 using a plurality of rivets or other suitable fasteners 126. When so configured, first plate portion 122 of rotary torque transmitting plate 144 may include a number of axially extending flanges 128 that are secured to first disc plate 86 using rivets or other suitable fasteners 130. Among other methods of manufacture, flange 128 may be stamped from a generally flat, annular plate.

Operation of rotational coupling assembly will be described with reference to FIGS. 3-3B, which illustrate the relationship between splines 76, 78 during various stages of rotation of first and second rotary torque transmission members 54 and 56, and to FIG. 4, which graphically illustrates torque transmission versus rotational displacement characteristics of rotational coupling assembly 24 according to an embodiment of the present invention. Prior to engine start-up, torsionally compliant component 52 is not under load and first and second rotary torque transmitting members 54, 56 are in a pre-displaced position (see, e.g., FIG. 4, Point A, and FIG. 3). After the engine is started and torsionally compliant component 52 is loaded, first and second rotary torque transmitting members 54, 56 rotate relative to one another (see, e.g., FIG. 4, Section B, and FIG. 3A). It is during this state of operation that torque is transmitted through torsionally compliant component 52 only.

The inertial mass of clutch input shaft 28 and input hub 30 cause engine flywheel 22 to apply a relatively high impact load on torsionally compliant component 52 during engine start-up and other high-load operating states. When torsionally compliant component 52 is overloaded, a portion of the torque transmitted by rotational coupling assembly 24 is carried by torsionally compliant component 52 and the remainder is redirected and carried by torque overload protection component 60 by virtue of first spline 76 engaging second spline 78. Torsionally compliant component 52 may be deemed overloaded when, for example, when first and second rotary torque transmitting members 54, 56 are incapable of further relative rotation. The point at which a portion of the torque transmitted by torsionally compliant component 52 is redirected through torque overload protection component 60 is shown in FIG. 3B and represented graphically at Point C in FIG. 4.

Although rotational coupling assembly 24 of the present invention was described as being used in a dual mass clutch system, rotational coupling assembly 24 may be used in other applications requiring torsional compliance.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A rotational coupling assembly for transmitting torque between a driving member and a driven member, comprising:
a torsionally compliant component including first and second rotary torque transmitting members rotatable relative to one another throughout a first angular distance, and a compliant member that provides a resilient driving connection between the first and second rotary torque transmitting members within the first angular distance; and
a torque overload protection component secured for rotation with the driving member and rotatable relative to the second rotary torque transmitting member throughout a second angular distance, the torque overload protection component including a rotation limiting connector adapted to selectively establish a driving connection between the torque overload protection component and the second rotary torque transmitting member to limit the amount of torque transmitted through the torsionally compliant component.

2. The rotational coupling assembly of claim 1, wherein the overload protection component includes a rotary torque transmitting plate secured for rotation with the driving member, the rotary torque transmitting plate including a first spine and the second rotary torque transmitting member including a second spline adapted to mate with the first spline to establish the driving connection when rotation of the rotary torque transmitting plate relative to the second rotary torque transmitting member exceeds the second angular distance.

3. The rotational coupling assembly of claim 2, wherein the first rotary torque transmitting member and the rotary torque transmitting plate are secured for rotation with the driving member.

4. The rotational coupling assembly of claim 2, wherein the second rotary torque transmitting member is secured for rotation with the driven member.

5. The rotational coupling assembly of claim 1, wherein the overload protection component includes a first rotary torque transmitting plate secured for rotation with the driving member and a second rotary torque transmitting plate secured for rotation with the second rotary torque transmitting member, the first rotary torque transmitting plate including a first spine and the second rotary torque transmitting plate including a second spline adapted to mate with the first spline to establish the driving connection when rotation of the first rotary torque transmitting plate relative to the second rotary torque transmitting plate exceeds the second angular distance.

6. The rotational coupling assembly of claim 5, wherein the second rotary torque transmitting plate is secured to the second rotary torque transmitting member by at least one fastener.

7. The rotational coupling assembly of claim 5, wherein the second rotary torque transmitting plate is secured to the second rotary torque transmitting member by a shrink-fit or press-fit style connection.

8. The rotational coupling assembly of claim 5, wherein the second rotary torque transmitting plate includes a polygon-shaped opening and the second rotary torque transmitting member includes a correspondingly shaped outer surface received within the polygonal-shaped opening.

9. The rotational coupling assembly of claim 1, wherein the first rotary torque transmitting member includes a first disc plate, the second rotary torque transmitting member includes a hub having a second disc plate, and the compliant member includes a resilient polymeric coupler secured to each of the first and second disc plates.

10. The rotational coupling assembly of claim 1, wherein the first rotary torque transmitting member includes a first disc plate having a plurality of spring pockets, the second rotary torque transmitting member includes a hub having at least one second disc plate that includes a plurality of spring cavities, and the compliant member includes a plurality of springs disposed within the spring pockets in the first disc plate and the spring cavities in the second disc plate.

11. The rotational coupling assembly of claim 1, wherein the second angular distance is less than or substantially equal to the first angular distance.

12. A rotational coupling assembly for transmitting torque between an engine flywheel and a clutch, comprising:
a torsionally compliant component including first and second rotary torque transmitting members rotatable relative to one another throughout a first angular distance and a compliant member that provides a resilient driving connection between the first and second rotary torque transmitting members within the first angular distance, the first rotary torque transmitting member including a first disc plate secured to the engine flywheel, the second rotary torque transmitting member including a clutch input shaft connected hub having at least one second disc plate, and the compliant member including one of a resilient polymeric coupler and a plurality of springs; and
a torque overload protection component including a rotary torque transmitting plate secured for rotation with the engine flywheel and rotatable relative to the second rotary torque transmitting member throughout a second angular distance that is less than or substantially equal to the first angular distance, the overload protection component including a rotation limiting connector adapted to selectively establish a driving connection between the overload protection component and the second rotary torque transmitting member to limit the amount of torque transmitted through the torsionally compliant component.

13. A torque transmitting device, comprising:
a driving member;
a rotational coupling assembly secured for rotation with the driving member, the rotational coupling assembly including:
a torsionally compliant component including first and second rotary torque transmitting members rotatable relative to one another throughout a first angular distance and a compliant member that provides a resilient driving connection between the first and second rotary torque transmitting members within the first angular distance; and
a torque overload protection component secured for rotation with the driving component and rotatable relative to the second rotary torque transmitting member throughout a second angular distance, the overload protection component including a rotation limiting connector adapted to selectively establish a driving connection between the overload protection component and the second rotary torque transmitting member to limit the amount of torque transmitted through the torsionally compliant component; and
a driven member connected to the rotational coupling assembly.

14. The torque transmitting device of claim 13, wherein the overload protection component includes a rotary torque transmitting plate secured for rotation with the driving member, the rotary torque transmitting plate including a first spine and the second rotary torque transmitting member including a second spline adapted to mate with the first spline to establish the driving connection when rotation of the rotary torque transmitting plate relative to the second rotary torque transmitting member exceeds the second angular distance.

15. The torque transmitting device of claim 14, wherein the first rotary torque transmitting member and the rotary torque transmitting plate are secured for rotation with the driving member.

16. The torque transmitting device of claim 15, wherein the second rotary torque transmitting member is secured for rotation with the driven member.

17. The torque transmitting device of claim 13, wherein the overload protection component includes a first rotary torque transmitting plate secured for rotation with the driving member and a second rotary torque transmitting plate secured for rotation with the second rotary torque transmitting member, the first rotary torque transmitting plate including a first spine and the second rotary torque transmitting plate including a second spline adapted to mate with the first spline to establish the driving connection when rotation of the first rotary torque transmitting plate relative to the second rotary torque transmitting plate exceeds the second angular distance.

18. The torque transmitting device of claim 17, wherein the second rotary torque transmitting plate is secured to the second rotary torque transmitting member by a plurality of fasteners.

19. The torque transmitting device of claim 17, wherein the second rotary torque transmitting plate is secured to the second rotary torque transmitting member by a shrink-fit or press-fit style connection.

20. The torque transmitting device of claim 17, wherein the second rotary torque transmitting plate includes a polygon-shaped opening and the second rotary torque transmitting member includes a correspondingly shaped outer surface received within the polygonal-shaped opening.

21. The torque transmitting device of claim 13, wherein the first rotary torque transmitting member includes a first disc plate, the second rotary torque transmitting member includes a hub having a second disc plate, and the compliant member includes a resilient polymeric coupler secured to each of the first and second disc plates.

22. The torque transmitting device of claim 13, wherein the first rotary torque transmitting member includes a first disc plate having a plurality of spring pockets, the second rotary torque transmitting member includes a hub having at least one second disc plate that includes a plurality of spring cavities, and the resilient compliant member includes a plurality of springs disposed within the spring pockets in the first disc plate and the spring cavities in the second disc plate.

23. The torque transmitting device of claim 13, wherein the second angular distance is less than or substantially equal to the first angular distance.

24. The torque transmitting device of claim 13, wherein the driven member is a clutch.

25. The torque transmitting device of claim 24, wherein clutch is one of a ball-ramp actuated clutch, a fluid pressure actuated clutch and a centrifugally actuated clutch.
